(19) United States
(12) Patent Application Publication
(10) Pub. No.: US 2016/0058231 A1
(43) Pub. Date: Mar. 3, 2016

(54) METHOD FOR CARRYING OUT A COOKING PROCESS

(71) Applicant: Convotherm Elektrogeraete GmbH, Eglfing (DE)

(72) Inventor: Michael Schilling, Peissenberg (DE)

(21) Appl. No.: 14/835,807

(22) Filed: Aug. 26, 2015

(30) Foreign Application Priority Data
Aug. 26, 2014 (DE) 102014216999.2

(51) Int. Cl. A47J 27/00; A47J 36/32

(52) U.S. Cl. CPC A47J 27/004; A47J 36/32

(57) ABSTRACT

A method for carrying out a cooking process in a cooking space of a cooking appliance, comprising the following method steps: simultaneously introducing a plurality of different cooking products arranged on product trays and having associated base cooking parameters into the cooking space; determining at least one updated cooking parameter of each cooking product introduced into the cooking space as a function of the number of introduced product trays, the base cooking parameters, a pre-set optimisation value (T_{T}) and/or an optimisation value (Tₒₚₜ) which can be determined individually for an optimised cooking process which is to be carried out; initiating the optimised cooking process simultaneously for all introduced cooking products; and removing the fully cooked cooking products from the cooking space.

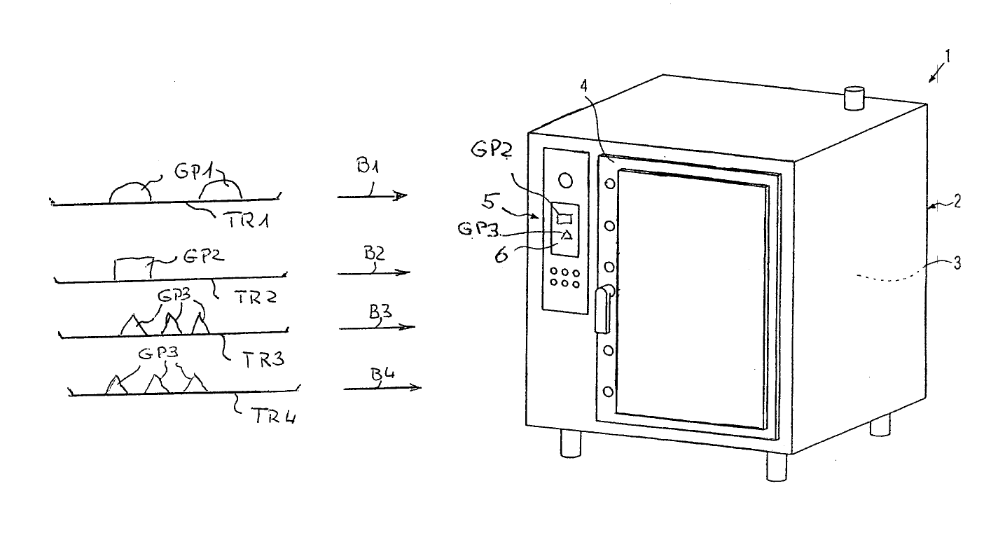

### CROSS-REFERENCED APPLICATIONS

This application claims priority to German Patent Application No. 102014216999.2, filed on Aug. 26, 2014, which is incorporated herein in its entirety by reference thereto.

### BACKGROUND

1. Field of the Disclosure

The present disclosure relates to a method for carrying out a cooking process.

2. Discussion of the Background Art

Investigations and tests carried out in the context of the disclosure have shown that in a cooking appliance, in particular a commercial cooking appliance, which is loaded with various products simultaneously and the associated cooking program initiated, because of the different product arrangements with different amounts that can respectively be combined with one another, the problem arises that the cooking times stored for the individual cooking programs or recipes are no longer optimally appropriate. This is due to the increased amount of cold cooking material introduced into the cooking space simultaneously. Further, the investigations carried out in the context of the disclosure have shown that it is not sufficient just to work on the basis of the total number of product trays loaded with cooking products and introduced into the cooking space, since the different amounts of product each have a greater or lesser effect on the total cooking times.

The results of these circumstances are:
increased fall in temperature after loading;
altered air movements in the cooking space; and
altered humidity value in the cooking space.

The object of the present disclosure is therefore to provide a method for carrying out a cooking process by which it is possible to prevent influences which have a negative effect on the cooking result.

### SUMMARY

In this context, the present disclosure is based on the idea of optimising the cooking processes of individual different recipes or cooking programs at the simultaneous start of mixed loading of the cooking space of the cooking appliance with respectively variable amounts. The optimisation may take place before, during or at the start of the individually assembled product loading, and is thus not a compensation method for what is known as rolling loading, such as is disclosed in DE 10 2011 109 398 A1. In this document, “rolling loading” means that a new batch of foodstuffs to be cooked, such as a fully loaded cooking material carrier, is introduced into the cooking space of the cooking appliance, in which other previously loaded batches are still located for which the target cooking time has not yet been reached. For the purpose of achieving a constant, reproducible quality of the cooked foodstuffs, DE 10 2011 109 398 A1 proposes not increasing the cooking time as is conventional in the art, but instead temporarily increasing a specific power input as a function of the amount of foodstuffs located in the cooking space of the cooking appliance. In this context, “specific power input” refers to the energy input per unit time. This specific power input can be provided by increasing the cooking space temperature by an offset value, by increasing the humidity of the cooking atmosphere and/or by increasing the air circulation in the cooking space.

By contrast, the present disclosure assumes that a previously completely empty cooking space is loaded from the beginning with a combination of different foodstuffs, in different amounts and optionally also on a different number of cooking product trays, and the cooking process is subsequently initiated for all foodstuffs simultaneously.

The necessary adaptation of the cooking process may take place by way of the time, temperature, humidity, air speed or other components characterising a cooking process. These components may include a percentage extra for opening the cooking space door when removing the cooking products, a percentage extra for the positioning of the trays and for the amount of cooking products arranged on the trays. In the case of a percentage extra for opening the cooking space door, this becomes smaller the further the cooking process has progressed. The core temperature of the cooked products can be used as a switch-off criterion. The adaptations may follow fixed and/or variable rules in this context.

By the definition of DE 10 2011 109 38, the foodstuffs or cooking products to be prepared by the method according to the disclosure may be “identical or similar foodstuffs”, meaning foodstuffs which can be cooked simultaneously and together in the same cooking space atmosphere, in other words in particular at the same temperature and the same humidity.

According to the disclosure, however, it is also conceivable for foodstuffs or cooking products which are prepared in different cooking space atmospheres to be able to be prepared by the method according to the disclosure, whilst observing particular upper and lower limits. One example is a foodstuff or cooking product which can be prepared for example at a cooking temperature of 200° C. in dry air, but with which other foodstuffs or coking products match which have for example 180° C. as a lower limit and 220° C. as an upper limit for the cooking temperature, thus observing a tolerance range of ±20° C. It is also possible to use an average of cooking parameters in cooking methods for cooking products which are to be prepared in different cooking space atmospheres.

If for example the individual cooking times of the individual recipes/cooking programs are to be adapted for the adaptation according to the disclosure, the following formula may be used:
Product 1 old cooking time=T1 old
Product 1 new cooking time=T1 new
Product 2 cooking time=T2
Product 3 cooking time=T3
Number of loaded trays of product 1=CoT1
Number of loaded trays of product 2=CoT2
Number of loaded trays of product 3=CoT3
“Mixed loading” optimisation value, for example in %,=Tₒₚₜ
“Number of trays” optimisation value, for example in %,=Tt

T1new=T1old+(T1old*Tt*(CoT1−1))+(T2*Tₒₚₜ*CoT2)+(T3*Tₒₚₜ*CoT3))

The value of Tₒₚₜ can be defined as an appliance constant, as a fixed/variable/dynamic value and/or specifically for each cooking product or recipe/cooking program. In this context, prioritisation may be provided, by way of which the cooking appliance detects which value Tₒₚₜ is to be used for a cooking process which is to be carried out.

The adaptation can also take place by way of an alteration to the cooking space climate (in particular the humidity) or an alteration to the fan rotational speed and/or the direction of rotation of the fan and the cooking temperature or other relevant components, as was described above.

Further details, features and advantages of the disclosure may be taken from the following description of an embodiment with reference to the drawings.

### BRIEF DESCRIPTION OF THE DRAWINGS

To illustrate the method according to the disclosure and the cooking appliance according to the disclosure, the single drawing provides a simplified representation thereof together with a simplified representation of product trays with cooking products arranged thereon.

### DETAILED DESCRIPTION OF THE PREFERRED EMBODIMENT

The drawing shows a cooking appliance 1 which comprises a housing 2 in which a cooking space 3 is arranged. The cooking space 3 can be opened and closed using a cooking space door 4.

A heating device (not shown in the drawing) is arranged in the cooking space 3, as well as a fan wheel, which can bring about movements of either dry air or humid air depending on the cooking process to be carried out.

The cooking appliance 1 is in particular a commercial cooking appliance, such as a hot-air steamer.

The cooking appliance 1 further comprises an operating device 5 which comprises a display device 6. Naturally, all of the other electrical and electronic components and other additional components of cooking appliances of this type are also provided.

The drawing further shows, purely by way of example, four product trays TR1, TR2, TR3 and TR4, which may also be referred to as cooking material carriers.

In the example situation, two cooking products GP1 are arranged on product tray TR1, one cooking product GP2 on product tray TR2, and three cooking products GP3 on each of product trays TR3 and TR4. As stated, the arrangement and number of the cooking products and the product trays is purely exemplary and may vary between applications.

The arrows B1 to B4 represent the loading of the product trays TR1 to TR4 into the cooking space 3 of the cooking appliance 1, after the cooking products GP1 to GP3 have been arranged on the product trays TR1 to TR4.

The cooking appliance 1 according to the disclosure may optionally have a function comprising automated allocated of cooking products, which takes place and is displayed fully automatically after selecting a cooking product, as is disclosed in EP 1 798 479 B2, the disclosure of which is hereby incorporated by reference in its entirety into the disclosure of the present application. This is represented in the drawing by the display device 6 with the display for the cooking products GP2 and GP3. In this example situation, as the first cooking product the operator finds the cooking product GP1 and inputs it into the device control system 5, which subsequently automatically selects the cooking products GP2 and GP3 and displays them to the operator as products which match the cooking product GP1 and which may thus be referred to as “identical or similar cooking products” in accordance with the explanations in the introduction, since they match one another in terms of cooking because of the cooking processes thereof o the associated cooking space atmospheres.

In a situation of this type, the cooking products GP1 to GP3 are prepared using a cooking process in which for example the cooking space temperature and the cooking space humidity are the same for all of the products GP1 to GP3. Nevertheless, because of differences in amount and constitution between the cooking products GP1 to GP3, and because of the number of products trays TR1 to TR4 introduced into the cooking space 3, there would be an influence on the cooking process, and without any adaptation to the cooking parameters, in the example situation the cooking time, this would lead to unsatisfactory cooking results.

In this example situation, the cooking appliance 1 would automatically carry out the aforementioned calculation of new cooking times T1new, T2new and T3new, taking into account the original or old cooking times T1old, T2old and T3old as well as the number of product trays (in the example situation one tray TR1, one tray TR2 and two trays TR3, TR4) using the stated formula.

After the respective calculations are carried out, in which for example an optimisation value T_{T} for the parameter of the number of product trays TR1 to TR4 would be set at for example 5%, which thus represents a fixed, pre-set optimisation value in the example situation, whilst the variable optimisation value Tₒₚₜ found in the formula is also calculated or determined depending on the product type and amount and may for example be 3%.

After the calculations are carried out, three new times T1new, T2new and T3new for the cooking products GP1 to GP3 will be provided, after which times the cooking products GP1 to GP3 are prepared in the desired manner and to the desired quality.

However, as is also stated above, it would also be possible according to the disclosure to combine cooking products with one another which are not “identical or similar foodstuffs” within the above definition, but which actually differ from one another in the cooking processes or cooking parameters thereof. In this case, a calculation of at least one of the cooking parameters explained above is also carried out, the products being in particular tolerance ranges as regards the cooking parameters thereof so as to be able to achieve the desired cooking results.

Thus, according to the disclosure, to carry out the method according to the disclosure one of the cooking products, such as the cooking product GP1 in the example situation shown, is initially selected, for example as desired by a customer, and arranged on the product TR1 in the desired number (in the example situation two GP1).

Subsequently, the remaining product trays TR2, TR3 and TR4 are loaded with the cooking products GP2 and GP3 and the product trays TR1 to TR4 loaded in this manner are arranged in the cooking space together before the respective cooking process is initiated.

The optimisation of the cooking process according to the method according to the disclosure takes place before, during or at the start of the cooking process. In this context, at least one updated cooking parameter is determined, such as the updated cooking times T1new, T2new and T3new of the respectively associated cooking products GP1, GP2 and GP3 in the example situation. This takes place as a function of the number of introduced product trays and of base cooking parameters, such as the cooking times T1old, T2old and T3old in the example situation, and of the described optimisation values Tₜ and Tₒₚₜ for determining an adapted cooking process to be carried out.

To carry out the cooking process, it is initiated simultaneously for all of the introduced cooking process GP1 to GP3, which are removed from the cooking space 3 again after the cooking process is finished.

Subsequently, the appliance settings are reset manually or automatically, in such a way that for a subsequent cooking process, in some cases with different cooking products, the original conditions are provided again in the cooking space or in the cooking space regulation.

According to the disclosure, in this context it is conceivable for all of the fully cooked cooking products GP1 to GP3 to be removed from the cooking space 3 simultaneously or in succession, depending on when the cooking times have passed, if the updated parameter, as stated by way of example above, is the cooking time.

However, as stated above, parameters for optimising the cooking process may also be the cooking temperature, the cooking temperature climate (in particular the cooking space humidity) or the fan rotational speed and/or the direction of rotation of the fan as well as other conceivable components.

As a further particularly preferred embodiment, it is possible for the display device 6 to display the updated cooking time, if this is the optimised parameter, after the optimisation, so as to be able to signal to the operator when the cooking process will be complete.

Within the stated tolerance ranges for cooking products having different cooking parameters from one another, it is also possible, using the method according to the disclosure, to keep the cooking time at the original value or to exceeded it at least only to a relatively small extent, in which case other cooking parameters affecting the cooking process are optimised for this purpose. This would be conceivable, to mention just one example, for foodstuffs such as chicken breast, chicken legs and chicken wings, for which the cooking temperature and cooking space climate are in such narrow tolerance ranges that the cooking time could be kept the same by influencing them.

In addition to the above written disclosure, reference is hereby explicitly made to the representation of the disclosure in the drawing.

### LIST OF REFERENCE NUMERALS

1 Cooking appliance
2 Housing
3 Cooking space
4 Cooking space door
5 Operating device
6 Display device
GP1-GP3 Cooking products
TR1-TR4 Product trays
B1-B4 Loading arrows

What is claimed is:

1. Method for carrying out a cooking process in a cooking space of a cooking appliance, comprising the following method steps:
simultaneously introducing a plurality of different cooking products arranged on product trays and having associated base cooking parameters into the cooking space;
determining at least one updated cooking parameter of each cooking product introduced into the cooking space as a function of the number of introduced product trays, the base cooking parameters, a pre-set optimisation value and/or an optimisation value which can be determined individually for an optimised cooking process which is to be carried out;
initiating the optimised cooking process simultaneously for all introduced cooking products; and
removing the fully cooked cooking products from the cooking space.

2. Method according to claim 1, wherein the updated cooking parameter is the cooking time.

3. Method according to claim 1, wherein the updated cooking parameter is the cooking space climate, in particular the cooking space humidity and/or the cooking temperature.

4. Method according to claim 1, wherein the updated cooking parameter is a rotational speed and/or the direction of movement of a fan arranged in the cooking space.

5. Method according to claim 1, wherein the fully cooked cooking products are removed from the cooking space simultaneously.

6. Method according to claim 1, wherein the fully cooked cooking products are removed from the cooking space in succession.

7. Method according to claim 1, wherein the optimisation value which can be determined individually is calculated or set.

8. Method according to claim 1, wherein after a first cooking product is selected the cooking appliance automatically selects and displays cooking products matching the first cooking product.

9. Method according to claim 1, wherein after the selected cooking parameter is optimised the optimisation value is displayed.

10. Method according to claim 1, wherein the selected cooking products have the same base cooking parameters apart from the cooking time.

11. Method according to claim 1, wherein the selected cooking products have different base cooking parameters.

12. Method according to claim 1, further comprising a core temperature of the cooking products, preferably determined by a core temperature probe, is used as a switch-off criterion for the cooking process.

13. Cooking appliance, in particular a commercial cooking appliance, for carrying out the method according to claim 1, said cooking appliance comprising an operating device for optimising of the cooking process by way of updated cooking parameters.
